(19) United States
(12) Patent Application Publication
(10) Pub. No.: US 2008/0017071 A1
(43) Pub. Date: Jan. 24, 2008

(54) Aqueous Binder Dispersion Comprising Nanoparticles, Method for the Production Thereof, and Use Thereof

(76) Inventors: Helmut Moebus, Freinsheim (DE); Volker Ptatschek, Goldbach (DE); Gerhard Leinz, Krefeld (DE); Matthias Hoelderle, Krefeld (DE)

Correspondence Address: MARSHALL & MELHORN, LLC, FOUR SEAGATE - EIGHTH FLOOR, TOLEDO, OH, 43604, US

(21) Appl. No.: 11/632,569

(22) PCT Filed: Jul. 18, 2005
(86) PCT No.: PCT/EP05/07806

§ 371 Date: Sep. 24, 2007

(30) Foreign Application Priority Data
Jul. 16, 2004 (DE) 10 2004 034 368.3

(51) Int. Cl. C08J 3/03; B01F 17/54; C08J 3/205; C09D 7/12; C09J 11/04

(52) U.S. Cl. 106/287.24; 516/77; 516/87; 516/89; 516/90; 516/93

(57) ABSTRACT

The invention relates to an aqueous dispersion comprising nanoscale polymer particles comprising organic binding agents, nanoparticles being contained in the latter as highly disperse phase, in addition water and/or an aqueous colloidal solution of a metal oxide as continuous phase and possibly supplements and additives. Aqueous compositions of this type are used as paint composition for coating purposes.

The invention relates to an aqueous binding agent dispersion comprising a polymer and/or oligomer organic binding agent and inorganic nanoparticles, nanoscale polymer particles being dispersed in water or in an aqueous colloidal solution and these nanoscale polymer particles covering the inorganic nanoparticles. The invention relates furthermore to a method for producing an aqueous binding agent dispersion of this type and to the use thereof.

Substances which can be hardened with UV/VIS- or electron beams in the form of 100% polymers and/or oligomers and also further polymers and oligomers, such as e.g. polyols for 2K polyurethanes or physically drying paints which contain organic solvents, can be filled with nanoparticles. In WO 03/44099, the stabilisation of nanoparticles by means of adsorptive particle organophilisation is described. The polymerisable metal oxide nanoparticles described under DE 198 46 660 can also be used to produce nanoparticle-containing coating materials. In DE 199 61 632 the in situ organophilisation of nanoscale materials in radiation-hardening paints by means of bifunctional silanes is described. Nanoparticles which are produced in situ in the polymer or oligomer by means of sol-gel technology are known from DE 199 24 644. Radiation-hardening formulations are used preferably.

The filled 100% substances are characterised by increased viscosity relative to the original polymers and/or oligomers, which has a negative effect on the flow properties during the coating process. Hence low layer thicknesses cannot be achieved and application methods, such as spraying or pouring, are not possible.

If it is desired to endow the coating to be produced also with elastic or viscoplastic properties, high-molecular and hence high-viscosity initial substances must be used. Low-molecular polymers and oligomers with a correspondingly reduced viscosity or reactive thinner cause the layers to become brittle. The inner stresses occurring and amplified during the hardening process have a negative effect on the adhesion, the elasticity and the scratch and abrasion behaviour. In addition, the danger exists of crack formation.

Aqueous radiation-hardening, nanoparticle-containing coating compositions are known from U.S. Pat. No. 4,478,876 and U.S. Pat. No. 5,260,350. They comprise water-soluble acrylates, bifunctional silanes with hydrolysable alkoxy and acryloxy groups and also colloidal aqueous silica sols. Because of the water solubility, exclusively low-molecular and highly alkoxylated (meth)acrylates which provide coatings with low mechanical and chemical stability are used.

DE 102 21 010 and DE 102 21 007 describe nanoparticle-containing aqueous dispersions. The polymer dispersion and nanoparticle dispersion are produced separately and mixed together subsequently. The addition of 1-10% amphiphiles, e.g. low-molecular alcohols such as isopropanol, are necessary here. Similarly, aqueous PU dispersions are mixed with colloidally dissolved nanoparticles in DE 100 04 499 in order to produce nanoparticle-containing coating materials. Alcohols are also used here but the use of organic solvents is often proscribed for reasons of economy, explosion protection and ecology.

DE 198 11 790 A1 relates furthermore to transparent paint binding agents which contain nanoparticles and have improved scratch resistance. According to the disclosure content of this document, the nanoparticle powders are firstly incorporated into the solvent by means of dissolvers and subsequently the nanoparticle slurries are deagglomerated by means of the nozzle jet dispersion process.

Starting herefrom, it was the object of the present invention to provide an aqueous binding agent dispersion for coating purposes, with which a high degree of nanoparticles can be achieved in the dispersion and the dispersion being able to be applied in painting and coating technology and also in adhesive applications with conventional methods, such as roller-coating, spraying, painting, pouring or rolling. The binding agent dispersion should in addition be simple to produce.

This object is achieved by the aqueous binding agent dispersion having the features of claim 1 and by the method for the production thereof having the features of claim 29. The use of the aqueous dispersion is indicated in claim 30. The further dependent claims reveal advantageous developments.

According to the invention, a binding agent dispersion is therefore proposed, in which the polymer particles cover the inorganic nanoparticles. These polymer particles containing nanoparticles are then dispersed in water or in an aqueous colloidal solution. The core of the present invention can hence be seen in the fact that a binding agent dispersion or emulsion is made available, in which the nanoparticles are contained in the binding agent particles themselves.

Surprisingly, it was able to be shown that binding agents selected in this manner, in which nanoparticles are contained highly dispersely, are exceptionally suitable for the current painting and coating technologies, and also adhesive applications. Processing of the dispersions or emulsions according to the invention comprising the binding agent particles which are filled with nanoparticles and of increased viscosity, dispensing with reactive thinners and organic solvents, is similar to processing of other aqueous products, as is known nowadays with aqueous alkyd resins and with aqueous dispersions, e.g. of styrene, acrylic and polyurethane (co)-polymers.

It is now possible with the help of the aqueous polymer dispersion according to the invention to begin with significantly higher-molecular and higher-viscosity polymers or oligomers and to fill these to a high degree with nanoparticles. Comparable coating compositions have to date not been able to be applied or only with increased temperature as nanoparticle-reinforced coating. Thanks to the aqueous polymer dispersion according to the invention, low-viscosity coating materials are now available which can be applied at a normal temperature and with the normal application techniques. The coatings which are obtained do however have the same positive application properties as the high-molecular, high-viscosity polymers or oligomers reinforced with nanoparticles and used for production thereof.

The aqueous polymer dispersion preferably contains a polymer and/or oligomer which is radiation-hardening. UV/VIS-, α-, γ-electron beams or other energy-rich beams are possible for this purpose.

It is however also possible that the aqueous polymer dispersion contains a non-radiation-hardening polymer and/or oligomer which is e.g. air-drying, forced-drying or drying under stoving conditions, said polymer and/or oligomer being able to be used both in single-component and in multi-component coating agents and being able to contain if necessary solvents. There are included herein preferably compounds from the group of alkyd resins, phenol resins, urea resins, melamine resins, saturated and unsaturated polyester resins, polyurethanes, polyurethane prepolymers, polyisocyanates, polyurethane prepolymers and polyisocyanates capped with protective groups, polyols, polymethyl(meth)acrylates and further polyalkyl(meth)acrylates, polyvinylbutyrals, further polyvinyl acetals, polyvinyl acetates and copolymers of vinyl acetate, polyethylene, copolymers of ethylene or graft copolymers of polyethylene, in particular ethylene acrylic acid copolymers or maleic acid-graft-polyethylene, poly-α-olefins, in particular polybutene, polyvinyl alcohols, polyvinyl chlorides, polyvinylidene chlorides, chlorinated polyethylenes and other chlorinated polyolefins, silicone resins and epoxy resins.

The polymer thereby preferably has a molecular weight of at least 500 g/mol, particularly preferred of at least 800 g/mol to max. 500,000 g/mol. There are used as polymers and/or oligomers those preferably which have at least one α,β-ethylene-unsaturated group per molecule. There are included herein compounds from the group of polyurethane(meth)acrylates, polyester(meth)acrylates, polyether(meth)acrylates, silicone(meth)acrylates and novolac acrylates. It is thereby preferred if the polymers/oligomers concern dendritic and/or hyperbranched polyester-, polyurethane-, polyether(meth)acrylates, epoxy(meth)acrylates, polyalkyl(meth)acrylates. In the case where the polymer/oligomer is a polyurethane, the molecular weight is preferably between 5,000 and 50,000 g/mol, for acrylic copolymers between 10,000 and 500,000 g/mol.

Examples of the polymers and oligomers contained in the aqueous composition are:

polyurethane acrylates, e.g. Craynor CN 925, CN 981 of Cray Valley Kunstharze, GmbH, Ebecryl EB 1290, Ebecryl 270 of UCB Chemie GmbH,

polyester acrylates, e.g. Laromer LR 8800 of BASF AG, Ebecryl EB 830 of UCB Chemie GmbH,

polyether acrylates, e.g. Craynor CN 503 of Cray Valley Kunstharze, GmbH, Laromer 8997 of BASF AG,

epoxy acrylates, e.g. Ebecryl EB 860 of UCB Chemie GmbH, Craynor CN 104 of Cray Valley Kunstharze GmbH,

dendritic polyester/ether acrylates, e.g. Actilane 881 of the company Akzo Nobel UV resins,

polyalkyl(meth)acrylates, e.g. Craynor CN 301 of Cray Valley Kunstharze GmbH,

silicone(meth)acrylates, e.g. Ebecryl EB 1360 of UCB Chemie GmbH,

novolac acrylates, e.g. Craynor CN 112C60 of Cray Valley Kunstharze GmbH,

alkyd resins, e.g. Vialkyd TO 607/50 IRH of UCB Chemie GmbH, Uralac AN620 X-70 of DSM Coating Resins,

phenol resins, e.g. Phenodur PR 401/72B of UCB Chemie GmbH

urea resins, e.g. Plastopal EBS 400 B of BASF AG,

melamine resins, e.g. Maprenal MF 915/75IB of UCB Chemie GmbH,

saturated polyester resins, e.g. Dynapol LH 831-24 of Degussa AG,

unsaturated polyester resins, e.g. Roskydal 500 A of Bayer AG, Viapal UP 156 E/68 of UCB Chemie GmbH,

polyurethane polymers and the precursors thereof in the form of polyisocyanates, polyols, polyurethane prepolymers as capped prepolymer and as reacted-out polyurethanes in the form of a melt or solution. These are in detail:

polyols in the form of polyethers, e.g. Voranol CP 3055 of Dow Chemicals, PolyTHF 2000 of BASF AG,

polyesters, e.g. Lupraphen 8107, Lupraphen 8109 of Elastogran GmbH, Desmophen 670 of Bayer AG, Oxyester T 1136 of Degussa AG,

alkyd resins, e.g. WorléeKyd C 628 of Worlée Chemie GmbH,

polycarbonates, e.g. Desmophen C 1200, Desmodur XP 2407 of Bayer AG,

hydroxyl polyacrylates, e.g. Desmophen A 365 of Bayer AG,

polyisocyanates, e.g. Desmodur N 3300, Desmodur VL, Desmodur Z 4470 of Bayer AG, Vestanat T 1890 L of Degussa AG, Rhodocoat WT 2102 of Rhodia Syntech GmbH,

polyisocyanates capped with protective groups, e.g. Desmodur BL 3272 MPA of Bayer AG,

polyurethane prepolymers, e.g. Desmodur E 4280 of Bayer AG, Vestanat EP-U 523A of Degussa AG,

polyurethane prepolymers capped with protective groups, e.g. Vesticoat UB 1256-06 of Degussa AG,

polymethyl methacrylate (PMMA) and further poly(meth)alkyl acrylates, e.g. Plexisol P 550 and Degalan LP 50/01 of Degussa AG,

polyvinyl butyral and other polyvinyl acetals, e.g. Mowital B 30 HH of Kuraray Specialties Europe GmbH,

polyvinyl acetate and copolymers thereof, e.g. Vinnapas B 100 of Wacker-Chemie GmbH,

polyvinyl alcohols, e.g. Mowiol 20-98 of Kuraray Specialties Europe GmbH,

polyvinyl chlorides, e.g. Laroflex MP 45 of BASF AG,

silicone resins, e.g. Silres EP of Wacker-Chemie GmbH,

epoxy resins, e.g. Beckopox EP 301, Beckopox EP 140 of UCB Chemie GmbH,

copolymers of vinyl acetate, e.g. Veova 9 of Deutsche Shell Chemie GmbH, polybutenes, e.g. Polybutene 025 of Kemat Belgium S.A.

polyvinylidene chlorides (PVDC), e.g. IXAN PNE 275 of SolVin Solvay S.A.

Fischer-Tropsch waxes, e.g. Sasolwax C80 of Sasol Wax GmbH,

paraffin waxes, e.g. Sasolwax 6805 of Sasol Wax GmbH,

micronised polyethylene waxes, e.g. Sasolwax 9480 of Sasol Wax GmbH,

coumarone-indene resins, e.g. Novarez C 80 of Rütgers Chemicals AG,

carnauba wax, e.g. of H. Erhard Wagner GmbH,

montan wax, e.g. Waradur B of Völpker Montanwachs GmbH,

rosin resin, e.g. of Keyser & Mackay GmbH,

beeswax, e.g. Cera Alba of Co. Kahl & Co. Vertriebsges mbH,

linseed oil, e.g. linseed oil, blown by Alberdingk Boley GmbH.

In all the polymers, both the aliphatic and the aromatic and araliphatic variants are expressly included.

In the case of the aqueous binding agent dispersions and emulsions according to the invention, the polymer particles thereby preferably have an average particle diameter between 30 and 500 nm, particularly preferred between 50 and 150 nm. The nanoparticles which are contained in the polymer particles must, since they are covered by the polymer of the polymer particle, have a smaller particle diameter than the polymer particles themselves. The inorganic nanoparticles can thereby have a diameter of 1 to 450 nm, preferably of 1 to 200 nm. According to the present invention, it is thereby also adequate if the nanoparticles are covered only on the surface by the polymer and/or the oligomer. The present invention also includes polymer particles of this type.

The aqueous binding agent dispersion according to the invention preferably contains 5 to 65% by volume, preferably 5 to 50% by volume, of polymer particles which contain nanoparticles, relative to the total composition. It has furthermore proved to be advantageous if, in the case of the binding agent dispersion according to the invention, 0.5 to 30% by volume of nanoparticles, preferably 0.5 to 25% by volume, particularly preferred 8 to 17% by volume, are contained in the polymer particles. The quantity of nanoparticles in the polymer particles should be selected according to which nanoparticles are used. If of concern thereby are nanoparticles of high density, such as e.g. zirconium dioxide, then a correspondingly greater initial weight should be used for achieving the same volume filling degrees.

The nanoparticles are preferably selected from the group of oxides, mixed oxides, carbides, borides and nitrides of elements of the main groups II to IV and/or elements of the sub-groups I to VIII of the periodic table including the lanthanides. Nanoparticles comprising silicon dioxide, aluminium oxide, cerium oxide, zirconium oxide and titanium dioxide are particularly preferred.

Examples of nanoparticles in the form of powders are silicon dioxides, e.g. pyrogenic silicic acids, such as Aerosil 200, Aerosil TT 600, Aerosil OX 50 and Aerosil 7200 by the company Degussa AG or nanoscale silicon dioxides produced by means of plasma processes, such as e.g. KADESIT040-100 of the company KDS NANO, titanium dioxides, such as pyrogenic titanium dioxide P25 of the company Degussa AG, or Hombitec RM 300 of the company Sachtleben Chemie GmbH, aluminium oxides, e.g. pyrogenic aluminium oxide C of the company Degussa AG or e.g. PüreNano™ aluminium oxide, produced by means of plasma processes, of the company NanoProducts Corporation or NanoDur™ aluminium oxide of the company Nanophase Technologies Corporation, in addition further nanoscale metal oxides which are produced by means of physical-chemical processes, such as e.g. flame pyrolysis or plasma processes, e.g. cerium oxides, such as NanoTek cerium oxide of the company Nanophase Technologies Corporation, zirconium oxides of the company Inocermic GmbH or NanoGard zinc oxide of the company Nanophase Technologies Corporation, nanoscale barium sulphates, e.g. Sachtoperse® HU-N of the company Sachtleben Chemie GmbH, laminar silicates, e.g. Nanofil® 15 of the company Süd-Chemie AG and nanoscale boehmites, e.g. Disperal of the company Sasol Chemical Industries Ltd.

According to the present invention it is furthermore possible that, in addition to the nanoparticles of the aqueous dispersion which are contained in the polymer particles, nanoparticles are also added, in a manner known per se, in a quantity of 0.5 to 20% by volume. Of these nanoparticles, also up to 100% by volume can then be replaced by microparticles with an average particle size between 450 nm to 200 μm.

Examples of microscale particles are silicic acids, e.g. Acematt® OK 412 or Acematt® TS 100 of the company Degussa AG, silica gels, e.g. Syloid ED 3 of the company Grace GmbH, quartz powders, e.g. Sikron Feinstmehl SF 3000 of the company Quarzwerke GmbH, cristobalite powders, e.g. Sibelite M 3000 of the company SRC Sibelco, titanium dioxides, e.g. Hombitan® R 210 of the company Sachtleben Chemie GmbH, aluminium oxides, e.g. Martoxid DN-430 of the company Martinswerk GmbH, zirconium silicates, e.g. zirconium silicate 16 my by the company Helmut Kreutz GmbH, siliceous earths, e.g. Sillitin Z 89 of the company Hoffmann Mineral GmbH & Co. KG, diatomites, e.g. Celite 110 of World Minerals Inc., talc, e.g. Finntalc M40 of the company Mondo Minerals Oy, kaolins, e.g. china-clay Grade D of the company Imerys, micas, e.g. Mica MU-M 2/1 of the company Ziegler & Co. GmbH, silicon carbides, e.g. Silcar G 14 of the company ESK-SIC GmbH, felspars, e.g. Minex 2 of the company Unimin Canada Ltd. wollastonites, e.g. Tremin 283-100 EST of the company Quarzwerke GmbH, glass powders, e.g. Boruvit B 200 of the company Ziegler & Co. GmbH, aluminium silicates intergrown with quartz, e.g. Siliplast 910 of the company Amberger Kaolinwerke Eduard Kick GmbH & Co. KG, and also all the mineral materials which can be produced by comminution or precipitation.

The nanoparticles on their surface are functionalised preferably by organic compounds which can have a reactive group relative to the binding agent and/or the educts. Examples of modified nanoparticle systems are e.g. silanised pyrogenic silicic acids, such as e.g. Aerosil 7200 of the company Degussa AG or polymerisable metal oxide nanoparticles (according to DE 198 46 660) which are accessible by reactive surface modification of metal oxide nanoparticles with e.g. silanes.

The reactive surface modification of the inorganic/metal oxide nanoparticles is achieved by covalent bonding of substances which can participate in addition or condensation reactions with functional groups of the surface, preferably with the hydroxyl groups. Following the method of DE 198 46 660, alkoxy silanes of the general formula (I) are proposed for this purpose:
R′₄₋ₓSi(OR)ₓ
in which the radicals R, the same or different from each other (preferably the same), represent possibly substituted (preferably unsubstituted) hydrocarbon groups with 1 to 8, preferably 1 to 6 and particularly preferred 1 to 4 carbon atoms (in particular methyl or ethyl), the radicals R′, the same or different from each other, respectively represent a possibly substituted hydrocarbon group with 1 to 20 carbon atoms and x is 1, 2 or 3.

Examples of radicals R′ in the above formula are alkyl, alkenyl, aryl, alkylaryl, arylalkyl, arylalkenyl, alkenylaryl radicals (preferably with respectively 1 to 12 and in particular 1 to 8 carbon atoms and including cyclic forms) which can be interrupted by oxygen, sulphur, nitrogen atoms or the group NR″ (R″=hydrogen or C₁₋₄ alkyl) and can carry one or more substituents from the group of halogens and the possibly substituted amino, amide, carboxy, mercapto, isocyanato, hydroxy, alkoxy, alkoxycarbonyl, acryloxy, methacryloxy or epoxy groups.

For particular preference there are amongst the above alkoxy silanes of the general formula (I) at least one, in which at least one radical R′ has a grouping, which can participate in a polyaddition (including polymerisation) or polycondensation reaction.

This grouping which is capable of polyaddition or polycondensation reaction concerns preferably an amino, hydroxy, epoxy group or (preferably activated) carbon-carbon multiple bonds (in particular double bonds), a (meth)acryloyl group being a particularly preferred example of the just-mentioned groupings.

Accordingly, particularly preferred organically modified alkoxy silanes of the general formula (I) for use in the present invention are those in which x is 2 or 3 and in particular 3 and a radical (the only radical) R′ stands for ω-glycidyloxy-C₂₋₆-alkyl or ω-(meth)acryloxy-C₂₋₆-alkyl.

Concrete examples of silanes of this type are 3-glycidoxypropyltri(m)ethoxysilane, 3,4-epoxybutyltrimethoxysilane and 2-(3,4-epoxycyclohexyl)ethyltrimethoxysilane and also 3-(meth)acryloxypropyltri(m)ethoxysilane and 2-(meth)acryloxyethyltri(m)ethoxysilane. Further examples of suitable compounds with x=1 or 2 are 3-glycidoxypropyldimethyl(m)ethoxysilane, 3-glycidoxypropylmethyldi(m)ethoxysilane, 3-(meth)-acryloxypropylmethyldi(m)ethoxysilane, 2-(meth)acryloxyethylmethyldi(m)ethoxysilane, 3-aminopropyltriethoxysilane, 3-mercapto-propyltrimethoxysilane.

The reactive surface modification of the inorganic/metal oxide nanoparticles can be effected however in the broadest sense with organometallic compounds of the general formula II
[(S-)ₒ-L-]ₘM(R)ₙ(H)ₚ
wherein the indices and the variables have the following meaning:

S reactive functional group;

L at least a bivalent organic cross-linking group;

H hydrolysable monovalent group or hydrolysable atom;

M bivalent to hexavalent main group- and sub-group metal;

R monovalent organic radical;

o a whole number from 1 to 5;

m+n+p a whole number from 2 to 6;

p a whole number from 1 to 6;

m and n zero or a whole number from 1 to 5;

for example isopropyltriisostearoyltitanate or neopentyl(diallyl)oxytrineodecanoylzirconate.

Examples of preparations are e.g. acrylate-based silica sols, e.g. HIGHLINK NanO G VTE 5968 of the company Clariant (France) S.A or e.g. Nanocryl XP 21/0930 of the company hanse chemie GmbH. Preparations of this type are in addition accessible by in situ organophilisation of metal oxide nanoparticles (e.g. according to DE 199 61 632), preferably silicon dioxide and aluminium oxide, with reactive organic and/or organometallic compounds, such as e.g. transition metal alkoxides or silanes, preferably bifunctional silanes, such as e.g. vinyltrimethoxysilane or 3-glycidyloxypropyltrimethoxysilane, in organic oligomers and polymers.

It is however equally possible that the nanoparticles on their surface are present modified by interaction with organic compounds. Examples of nanoparticles modified by means of adsorptive particle organophilisation are described in WO 03/44099. There are used preferably metal oxide nanoparticles, particularly preferred silicon dioxide and aluminium oxide nanoparticles, in formulations of organic polymers and/or oligomers, preferably in radiation-hardening polymers and/or oligomers with at least one α-,β-ethylene-unsaturated group.

According to a preferred embodiment, the aqueous composition contains as supplements and additives protective colloids and/or emulsifiers, in particular surfactants, amphiphiles or acids or bases as corresponding counterions for the emulsification of ionic polymers or oligomers.

The dispersion is effected preferably using emulsifiers. Non-ionic surfactants have proved best suited as emulsifiers for the dispersion of the radiation-hardening acrylate polymers and oligomers in the aqueous phase. Suitable emulsifiers are saturated and unsaturated fatty alcohol ethoxylates with 8 to 15 C-atoms in the fatty alkyl radical, alkylphenol ethoxylates with 6 to 13 C-atoms in the alkyl radical and 4 to 100 ethylene oxide units, preferably lauryl alcohol ethoxylates, isotridecanol ethoxylates and also octyl- and nonylphenol ethoxylates with 6 to 50 ethylene oxide units.

Also mixtures of those emulsifiers are very suitable, comprising a hydrophilic and a hydrophobic component in the ratio 1:5 to 5:1, e.g. one part lauryl alcohol 4 EO and three parts lauryl 40 EO. The emulsifiers are used in a total quantity of 0 to 15% by volume of the emulsion, preferably 0.8 to 10% by volume of the emulsion.

There are very suitable as emulsifiers also esters and ethoxylated esters of sorbitan, as are offered for sale under the trademarks Tween and Span. Preferably Tween 20 and Span 60 are in the ratio 1:1 to 1:7. For particular preference, 3 to 15% by volume of the hydrophobic emulsifier is replaced by oleyl sarcoside.

The obtained emulsions are stable in storage, without sedimentation and without a change in the particle size distribution.

The protective colloids and/or emulsifiers are thereby used preferably in a quantity of 0.1 to 10% by volume, relative to the total composition.

There are contained preferably as supplements and additives in the aqueous composition, catalysts, co-catalysts, radical formers, photoinitiators, photosensitisers, hydrophobing agents, matting agents, lubricants, defoamers, deaerators, wetting agents, flow-control agents, thixotropic agents, thickeners, inorganic and organic pigments, fillers, adhesives, corrosion inhibitors, UV stabilisers, HALS compounds, radical interceptors, antistatic agents and/or wetting agents.

There are used as supplements and additives in addition preferably water-soluble monomers which can be polymerised thermally and/or with energy-rich radiation, preferably (meth)acrylic acid, (meth)acrylamide, hydroxylethyl(meth)acrylate, vinyl phosphonic acid and vinyl sulphonic acid.

It is preferred furthermore if there are used as supplements/additives esters of meth(acrylic acid) with branched and/or linear C₁-C₁₆ alkyl radicals.

The aqueous dispersion preferably has a viscosity in the range of 1 to 800 mPas at 20° C.

Furthermore, the invention relates to a method for producing an aqueous binding agent dispersion as described above.

The method for producing the invention basically comprises two alternatives (patent claim 29 and patent claim 30).

It is proposed according to a first variant that the nanoparticles are dispersed with shearing into a water-free presented polymer phase and that, then in a second step, the polymer particles which contain nanoparticles are obtained by emulsification, with shearing, of the water-free polymer phase which contains nanoparticles in water and possibly with the addition of a protective colloid and/or emulsifier or further supplements and additives. In this method, firstly the water-free, nanoparticle-filled polymer phase is hence produced in a preceding step. The polymer phase can thereby concern a high polymer or also an oligomer. This thus produced water-free polymer phase is then mixed, with shearing, with the nanoparticles and the thus obtained mixture comprising the polymer phase and the nanoparticles is incorporated, with shearing, into an aqueous phase or into a colloidal phase, the corresponding polymer particles which contain nanoparticles being then formed. The method as described above can fundamentally thereby be applied for all the above-described polymers, particularly preferred for polyurethanes and polyacrylic copolymers.

According to a second variant, it is proposed according to the present invention that the nanoparticles themselves are added as educts already during production of the polymers and then the thus produced polymers which then already contain the nanoparticles are incorporated in turn, with shearing, into an aqueous or colloidal phase.

In the production method according to the second variant, i.e. in the case where the educts of the binding agents and the nanoparticles are converted in an “in situ process”, it is in addition advantageous if, during this production, reactive compounds are added, which can react with the binding agent and/or with the binding agent precursors and at the same time can participate in covalent or adsorptive interactions with the nanoparticle surfaces. Suitable for example are amino alcohols, amino carboxylic acids, polyamino carboxylic acids, polyamines, epoxysilanes, alkoxysilanes which contain ethylene-unsaturated mercaptosilanes and aminosilanes.

The aqueous compositions according to the invention are used as paint and coating composition. They are thereby used preferably for producing scratch-resistant, abrasion-resistant and adhesive layers, layers with increased tolerance to chemical or mechanical stress and/or barrier layers.

The subject according to the application is intended to be explained in more detail with reference to the following examples without restricting the latter to the special embodiments mentioned here.

### EXAMPLE 1

Production of the Nanoparticle-Filled Radiation-Hardening Acrylate Polymer I

A mixture comprising a) 5 parts by weight of a solution of 2 parts by weight of a lauryl sulphate (Sulfopon 101 Special) and 1 part by weight maleic anhydride in 97 parts by weight water in b), a mixture comprising 100 parts by weight CN 925 mixed with 0.2 parts by weight BHT and 0.2 parts by weight MEHQ are mixed at 60° C. in a high power dissolver provided with a toothed disc, an open, heatable and coolable agitated tank and a thermometer. 102.4 parts by weight of the thus obtained mixture are subsequently mixed in a plurality of equal aliquots with 10 parts by weight Dynasylan VTMO and 22.5 parts by weight Aerosil OX 50 and mixed intensively and, after complete introduction of the Dynasylan and the Aerosil, are reacted to completion, with shearing, at approx. 80° C. for 4 hours. In order to prevent overheating of the radiation-hardening acrylate polymer due to the introduction of the agitation energy, the container wall must if necessary be cooled. Subsequently the nanoparticle-filled radiation-hardening acrylate polymer I is cooled to room temperature. The resulting viscous material has an average viscosity of 10.0±3 Pas at 40° C.

### EXAMPLE 2

Production of the Nanoparticle-Filled Radiation-Hardening Acrylate Polymer II

A mixture comprising 100 parts by weight Ebecryl EB 270 with 0.8 parts by weight propyltrimethoxysilane and 0.2 parts by weight MEHQ is placed in a high power dissolver provided with a toothed disc, an open, heatable and coolable agitated tank and a thermometer, agitated intensively and 30 parts by weight aluminium oxide C (pyrogenic aluminium oxide, Degussa AG) are added in several portions. When a temperature of 60° C. is exceeded cooling takes place. After the addition is completed, agitation takes place subsequently at 60° C. for 2 hours. Subsequently the finished nanoparticle-filled radiation-hardening acrylate polymer II is cooled to room temperature. The resulting viscous material has a characteristic viscosity curve II above the shear speed and an average viscosity of 20±1 Pas at 40° C.

### EXAMPLE 3

Production of the Aqueous Emulsion of the Nanoparticle-Filled Radiation-Hardening Acrylate Polymer I

60 parts by weight water, 2 parts by weight lauryl alcohol-3-EO and 2 parts by weight lauryl alcohol-40-EO are placed in the high power dissolver provided with a toothed disc, an open heatable and coolable agitation tank and a thermometer and heated to 60° C. Subsequently, with vigorous shearing, 40 parts by weight of the nanoparticle-filled radiation-hardening acrylate polymer I which was preheated in advance likewise to 60° C., was added within 10 min. A white emulsion is produced with an average particle size of 290 nm and a particle size distribution coefficient of 6. By subsequent retreatment (subsequent shearing) of the emulsifying batch with an Ultraturrax (rotor-stator dispersing head, company Jahnke & Kunkel) within 10 min, the fine dispersion is effected up to a particle size of 190 nm and a particle size distribution coefficient of 4.

The obtained emulsion I is stable in storage and can be worked by spray application.

### EXAMPLE 4

Production of the Aqueous Emulsion of the Nanoparticle-Filled Radiation-Hardening Acrylate Polymer II

40 parts by weight of the nanoparticle-filled radiation-hardening acrylate polymer II is placed in the high power dissolver provided with a toothed disc, an open, heatable and coolable agitation tank and a thermometer and heated to 60° C. Subsequently, with vigorous shearing, 60 parts by weight water, 2 parts by weight lauryl alcohol-3-EO and 2 parts by weight lauryl alcohol-40-EO, which was preheated in advance likewise to 60° C., were added within 10 min. Whilst passing through a viscosity peak, a white emulsion is produced with an average particle size of 260 nm and a particle size distribution coefficient of 5. By subsequent retreatment (subsequent shearing) of the emulsifying batch with an Ultraturrax (rotor-stator dispersing head, company Jahnke and Kunkel) within 10 min the fine dispersion is effected up to a particle size of 120 nm and a particle size distribution coefficient of 3.

The obtained emulsion I is stable in storage and can be worked by spray application.

### EXAMPLE 5

100 parts by weight of the aqueous emulsion, obtained in the emulsifying example 1, of the nanoparticle-filled radiation-hardening acrylate polymer I are mixed with 3 parts by weight of a water-soluble azostarter (Wako V 44 of the company Wako) and are agitated for 10 min at RT until complete solution of the starter. Subsequently the emulsion which is ready for use is spray applied in a cross-wise operation onto a horizontally-situated 10 cm×10 cm plate made of ABS by means of an HVLP gun and left to evaporate at RT for at least 5 min until a clear, non-porous but sticky film with a layer thickness of 12 μm has formed on the surface. The thus coated plate is subsequently guided under an N₂-inerted UV lamp (160 W/cm, belt speed 10 m/min, 50-250 ppm oxygen). The layer is immediately hardened.

### EXAMPLE 6

100 parts by weight of the aqueous emulsion, obtained in the emulsifying example 2, of the nanoparticle-filled radiation-hardening acrylate polymer II are agitated with 3 parts by weight of a water-soluble photoinitiator Irgacure 500 and for 10 min at RT until complete solution of the starter and subsequently 4 parts by weight of a commercially available PU thickener (Tafigel PUR 61, company Münzing Chemie Heilbronn) are added and agitated until production of a slightly creamy consistency with shearing (run-out time 45 sec in 4 mm DIN beaker). Subsequently the paint which is ready for use is spray applied onto a vertically rotating cylinder of 10 cm height and a diameter of 50 mm made of primed wood by means of an HVLP gun in a cross-wise operation and is left to evaporate at RT for at least 5 min until a clear, non-porous but sticky film with a layer thickness of 15 μm has formed on the surface. The thus coated cylinder is subsequently hardened in an internally reflective 60 litre barrel with CO₂ atmosphere (<500 ppm oxygen) under a UVA lamp (400 W, 30 sec irradiation). The layer is subsequently completely hardened throughout.

### EXAMPLE 7

### Synthesis Example

187.4 g polyesteracrylate with a hydroxyl number of 80 mg KOH/g (commercial name Laromer LR 8800 of the company BASF) and 31.5 g N-ethylpyrrolidone were placed in a glass beaker, equipped with agitator, thermometer, reflux cooler and compressed air pass-over pipe.

To this initial weight there were added 0.06 g 3-tert-butyl-4-hydroxy-anisole. Subsequently, via a drop funnel, 83.9 g 4,4′-dicyclohexylmethanediisocyanate (commercial name Desmodur W of the company Bayer AG) were added in drops.

The total initial weight was agitated at 70° C. with a pass-over of compressed air and converted up to an NCO content of <=5.0%. The reaction was followed acidimetrically.

Thereafter, 9.5 g dimethylol propionic acid and 7.2 g triethyl amine were added.

The mixture was converted further at 75° C. to an NCO content of 2.8%.

Dispersion

After the conclusion of the reaction, the NCO-terminated prepolymer was dispersed with vigorous agitation in a mixture comprising 469 g demineralised water, 7.8 g monoethanol amine and 206 g Bindzil 305 FG (aqueous silica sol with FKG of 30% of the company EKA Chemicals).

A dispersion with the following characteristics was obtained:

Viscosity: 25 mPas

pH value: 8.2

Solids content: 35.4%

### COMPARATIVE EXAMPLES

The nanoparticle-filled radiation-hardening acrylate polymers I and II are not processible under the conditions of application example 1 and 2. A layer thickness of 10 to 12 μm cannot be achieved either with any of the other known application methods (knife-coating, rolling, roller-coating, pouring) because of the high viscosity.

1-37. (canceled)

38. An aqueous binding agent dispersion comprising a polymer and/or oligomerorganic binding agent and inorganic nanoparticles, and further comprising nanoscale polymer particles which are dispersed in water or in an aqueous colloidal solution and cover the inorganic nanoparticles.

39. The aqueous binding agent dispersion according to claim 38, wherein the average particle diameter of the polymer particles is between 30 and 500 nm.

40. The aqueous binding agent dispersion according to claim 39, wherein the average particle diameter is 50 to 150 nm.

41. The aqueous binding agent dispersion according to claim 38, wherein the at least one polymer and/or oligomer binding agent is radiation-hardening.

42. The aqueous binding agent dispersion according to claim 38, wherein the at least one polymer and/or oligomer binding agent can be emulsified in water and has at least one α,β-ethylene-unsaturated group per molecule.

43. The aqueous binding agent dispersion according to claim 38, wherein the at least one polymer and/or oligomer binding agent is selected from the group consisting of polyurethane(meth)acrylates, polyester(meth)acrylates, polyether(meth)acrylates, epoxy(meth)acrylates, polyalkyl(meth)acrylates, silicone(meth)acrylates and novolac acrylates.

44. The aqueous binding agent dispersion according to claim 43, wherein the at least one polymer and/or oligomer binding agent is selected from the group consisting of dendritic and/or hyperbranched polyester-, polyurethane- and/or polyether(meth)acrylates.

45. The aqueous binding agent dispersion according to claim 38, wherein the at least one polymer and/or oligomer binding agent is not radiation-hardening.

46. The aqueous binding agent dispersion according to claim 44, wherein the at least one polymer and/or oligomer binding agent is selected from the group consisting of alkyd resins, phenol resins, urea resins, melamine resins, saturated and unsaturated polyester resins, polyurethanes, polyurethane prepolymers, polyisocyanates, polyurethane prepolymers and polyisocyanates capped with protective groups, polyols, polymethyl(meth)acrylates and further polyalkyl(meth)acrylates, polyvinylbutyrals, further polyvinyl acetals, polyvinyl acetates and copolymers of vinyl acetate, polyethylene, copolymers of ethylene or graft copolymers of polyethylene, in particular ethylene acrylic acid copolymers or maleic acid-graft-polyethylene, poly-α-olefins, in particular polybutene, polyvinyl alcohols, polyvinyl chlorides, polyvinylidene chlorides, chlorinated polyethylenes and other chlorinated polyolefins, silicone resins and epoxy resins and also synthetic or natural waxes, synthetic or natural resins or synthetic or natural oils.

47. The aqueous binding agent dispersion according to claim 38, wherein the at least one polymer and/or oligomer binding agent has a molecular weight of at least 500 g/mol.

48. The aqueous binding agent dispersion according to claim 47, wherein the at least one polymer and/or oligomer binding agent is a polyurethane with a molecular weight of 5,000 to 50,000 g/mol.

49. The aqueous binding agent dispersion according to claim 47, wherein the at least one polymer and/or oligomer binding agent is an acrylic copolymer with a molecular weight of 10,000 to 500,000 g/mol.

50. The aqueous binding agent dispersion according to claim 38, wherein the inorganic nanoparticles have a diameter of 1 to 450 nm.

51. The aqueous binding agent dispersion according to claim 38, wherein the nanoparticles are present agglomerated and/or deagglomerated.

52. The aqueous binding agent dispersion according to claim 38, wherein the nanoparticles are present in monomodal and/or multimodal particle size distribution, in particular in bimodal particle size distribution.

53. The aqueous binding agent dispersion according to claim 38, wherein the nanoparticles are selected from the group consisting of oxides and/or mixed oxides, carbides, borides and nitrides of elements of the second to fourth main group and/or elements of the first to eighth sub-group of the periodic table including the lanthanides.

54. The aqueous binding agent dispersion according to claim 53, wherein the nanoparticles are selected from the group consisting of silicon dioxide, aluminium oxide, cerium oxide, zirconium oxide and titanium dioxide.

55. The aqueous binding agent dispersion according to claim 38, wherein the nanoparticles are functionalized on their surface by organic compounds.

56. The aqueous binding agent dispersion according to claim 55, wherein the organic compounds are bonded chemically to the particle surface or bonded adsorptively by interaction.

57. The aqueous binding agent dispersion according to claim 38, wherein 5 to 65% by volume of inorganic polymer particles which contain nanoparticles are contained, relative to the total composition.

58. The aqueous binding agent dispersion according to claim 57, wherein 0.5 to 30% by volume of inorganic nanoparticles are contained in the polymer particles.

59. The aqueous binding agent dispersion according to claim 38, wherein 0.5 to 20% by volume of inorganic nanoparticles are additionally contained in the aqueous phase of the polymer dispersion, relative to the total composition.

60. The aqueous binding agent dispersion according to claim 56, wherein up to 100% by volume of the additional nanoparticles are replaced by microparticles with an average particle size between 450 nm to 200 μm.

61. The aqueous binding agent dispersion according to claim 38, further comprising supplements and additives, protective colloids and/or emulsifiers, in particular surfactants, amphiphiles and, for the emulsification of ionic polymers or oligomers, acids or bases as counterions.

62. The aqueous binding agent dispersion according to claim 38, wherein 0.1 to 10% by volume of the protective colloid and/or of the emulsifier are contained, relative to the total composition.

63. The aqueous binding agent dispersion according to claim 38, further comprising supplements and additives, catalysts, co-catalysts, radical formers, photoinitiators, photosensitisers, hydrophobing agents, matting agents, lubricants, defoamers, deaerators, wetting agents, flow-control agents, thixotropic agents, thickeners, inorganic and organic pigments, fillers, adhesives, corrosion inhibitors, UV stabilisers, HALS compounds, radical interceptors and/or antistatic agents.

64. The aqueous binding agent dispersion according to claim 38, further comprising supplements/additives, polymerisable monomers, preferably (meth)acrylic acid, (meth)acrylamide, hydroxyethyl(meth)acrylate, vinyl phosphonic acid and vinyl sulphonic acid.

65. The aqueous binding agent dispersion according to claim 64, wherein there are used as supplements/additives esters of meth(acrylic acid) with branched and/or linear C₁-C₁₆ alkyl radicals.

66. A method for producing an aqueous binding agent dispersion according to claim 38, comprising dispersing the inorganic nanoparticles into a water-free presented polymer phase, with shearing, and obtaining the polymer particles which contain nanoparticles by emulsification, with shearing, of the water-free polymer phase which contains nanoparticles in water and optionally with the addition of a protective colloid and/or emulsifier or further supplements and additives.

67. A method for producing an aqueous polymer dispersion according to claim 38, comprising adding the nanoparticles as educts during production of the polymers and obtaining the polymer particles which contain nanoparticles by emulsification, with shearing, of the polymer which contains nanoparticles in water and optionally with the addition of a protective colloid and/or emulsifier or further supplements and additives.

68. The method according to claim 66, wherein the binding agent is polyurethane.

69. The method according to claim 66, wherein reactive compounds are added during production.

70. The method according to claim 69, wherein the reactive compounds are amino alcohols.

71. The method according to claim 70, wherein the reactive compounds are selected from the group consisting of amino carboxylic acids, polyamino carboxylic acids, gelatines and/or aminosilanes.

72. The method according to claim 66, wherein the production of the polymer particles is effected by an emulsion polymerisation.

73. A method of utilizing the aqueous binding agent dispersion according to claim 38, comprising the step of forming a coating or adhesive composition.

74. A method of utilizing the aqueous binding agent dispersion according to claim 70, comprising the steps of producing scratch-resistant, abrasion-resistant and adhesive layers, layers with increased tolerance to chemical or mechanical stress and/or increased UV light and/or weathering resistance and/or barrier layers.
